(19) United States
(12) Patent Application Publication
(10) Pub. No.: US 2005/0252607 A1
(43) Pub. Date: Nov. 17, 2005

(54) Microwave bonding

(76) Inventors: Christian Kirsten, Monheim (DE); Dieter Dausmann, Duesseldorf (DE); Uwe Franken, Neuss (DE); Nikolaus Mathes, Wuppertal (DE)

Correspondence Address: HENKEL CORPORATION, THE TRIAD, SUITE 200, 2200 RENAISSANCE BLVD., GULPH MILLS, PA, 19406, US

(21) Appl. No.: 11/168,768

(22) Filed: Jun. 28, 2005

Related U.S. Application Data
(63) Continuation of application No. 10/069,409, filed on May 31, 2002.

(30) Foreign Application Priority Data
Aug. 24, 1999 (DE) 199 40 128.4

(51) Int. Cl. B32B 31/00

(52) U.S. Cl. 156/272.4

(57) ABSTRACT

A process for bonding at least two substrates with a hotmelt adhesive using microwave energy is provided. The process includes applying a microwave-activatable primer to a least one of the substrates and applying a hotmelt adhesive to a least one of the substrates. The method also includes pressing the substrates together so that the microwave-activatable primer and the hot melt adhesive are between the substrates, and exposing at least the microwave-activatable primer to microwaves to heat the hotmelt adhesive. The present invention also provides a process for spraying a hot melt adhesive onto a substrate where the hot melt adhesive includes nanoparticles having ferromagnetic, ferrimagnetic, superparamagnetic or piezoelectric properties.

### CROSS REFERENCE TO RELATED APPLICATIONS

This application is a Continuation of U.S. application Ser. No. 10/069,409, filed May 31, 2002, which is a Continuation of PCT/EP00/07975, filed Aug. 16, 2000, which claims priority under 35 U.S.C. § 119 of DE 199 40 128.4, filed Aug. 24, 1999, which is incorporated herein by reference in its entirety.

### BACKGROUND OF THE INVENTION

This invention relates to a process for bonding porous and/or nonporous substrates with hotmelt adhesives, more particularly in shoe manufacture.

Requirements and specifications for an adhesive in shoe manufacture are described in EN 522 and EN 1392. A particularly important requirement is a high spotting tack which ensures exact positioning, for example of the sole on the shoe base. In addition, the quality/strength of the bond presupposes good penetration/wetting of the substrates to be bonded, particularly where they are porous and above all fibrous. These requirements conflict with one another, particularly where hotmelt adhesives are used. The prior art is based either on amorphous systems or crystalline formulations. Whereas amorphous hotmelt adhesives show adequate spotting tack, their penetration/wetting is unsatisfactory. Where crystalline systems are used, good penetration is generally present whereas their spotting tack for positioning the shoe sole is inadequate. Although amorphous or crystalline hotmelt adhesives can be optimized in regard to the described problems, such improvements are only ever achieved at the expense of the other requirement described above. Optimal spotting tack coupled with optimal penetration/wetting cannot be achieved solely by formulation in accordance with the prior art.

In known processes, the above-mentioned difficulties can only be overcome by additional and expensive process steps. DE 19504007, for example, describes the pre-heating or post-heating of substrates to improve the penetration of an amorphous hotmelt adhesive. An alternative way and, in many cases, the only way of obtaining a high-quality bond is the additional application of a primer and/or adhesive layer for carrying out contact bonding (two-way process). In many cases, this means that the objective of solventless bonding cannot be achieved.

WO 99/24520 describes a microwave-activatable adhesive which, besides its polymers, additionally contains a mixture of two components which are receptive to microwaves and which—in terms of size, shape and conductivity—are selected to increase the absorption of the microwaves in the polymeric composition. In order to bond wood, plastics and semiconductors to one another, the adhesive is said to be applied to one or both substrates in known manner, for example by spraying, and then exposed to microwave radiation, the adhesive forming a bond. The disadvantage of this adhesive is that it cannot be accurately or constantly applied by spraying and is therefore unsuitable for certain applications, for example in shoemaking for bonding soles.

Against the background of this prior art, the problem addressed by the present invention was to provide a process for bonding porous and nonporous materials where the strength requirements would be safely fulfilled and spray application of the adhesive would be unproblematic.

The solution to this problem is defined in the claims and consists essentially in the fact that the primer and not the adhesive contains additives which are receptive to microwaves and with which the adjacent adhesive layer can be activated.

### SUMMARY OF THE INVENTION

Accordingly, the present invention relates to a process for bonding porous and/or nonporous substrates with adhesives, more particularly hotmelt adhesives, in which
a) a microwave-activatable primer is applied to at least one substrate,
b) an adhesive, more particularly a hotmelt adhesive, is applied to at least one substrate,
c) both substrates with the primer and the adhesive or the hotmelt adhesive in between are exposed to microwaves and at the same time pressed together and
d) the microwave-heated adhesive is left to set.

Preferred embodiments of the invention can be found in the dependent claims.

### DETAILED DESCRIPTION OF THE INVENTION

So far as the microwave-active additives are concerned, reference is specifically made to WO 99/24520 of which the disclosure is hereby included as part of the disclosure of the present invention. In addition, however, it is pointed out that the primer may also contain nanoscale microwave-active additives. In this case, one component is sufficient.

So far as the bonding process is concerned, reference is made to WO 99/24498 of which the disclosure is also included as part of the subject matter of the present application.

The essential aspects of the present invention are discussed in the following.

The process according to the invention resolves the described limitation in the bonding of shoes.

Accordingly, the process according to the invention is based on the use of thermoplastic and/or reactive adhesive systems which can be selectively activated by electromagnetic radiation through the primary layer. Activation is based on locally defined heating of the primer layer and hence the adjacent adhesive layer. The bonded substrates are heated only slightly and ideally not at all, but at all events more slowly than the modified adhesive system with a microwave-active primer layer and hence are subjected to little or no heat stress. The activation of the adhesive layer through the primer layer in accordance with the invention differs significantly from the conventional activation processes presently used in the shoe industry (for example IR radiation, circulated hot air).

The locally defined heating of the adhesive layer through the primer layer in accordance with the invention is made possible by the modification of standard primers with suitable “signal receivers” which absorb electromagnetic energy, as described in WO 93/02867. For shoe adhesives, such signal receivers are, for example, quartz, tourmaline, barium titanate, lithium sulfate, potassium (sodium) tartrate, ethylenediamine tartrate, ferroelectric materials of perovskite structure and, above all, lead zirconium titanate. Where magnetic alternating fields are used, any ferrimagnetic, ferromagnetic or superparamagnetic materials are basically suitable, more particularly the metals aluminium, cobalt, iron, nickel or alloys thereof and metal oxides of the n-maghemite type (γ-Fe₂O₃) and the n-magnetite type (Fe₃O₄), ferrites with the general formula MeFe₂O₄, where Me stands for divalent metals from the group consisting of copper, zinc, cobalt, nickel, magnesium, calcium or cadmium. Carbon blacks and carbon fibers are also suitable. In addition, it essentially contains the known components for primers, for example chloramine, chlorinated polyolefins, polychloroprene or polyurethane. These components are preferably selected according to the hotmelt adhesive components and the substrates.

The primer is preferably applied to at least one substrate in the form of a solution or dispersion.

Suitable adhesives are, in principle, any known adhesives providing they are sprayable, more particularly sprayable hotmelt adhesives. In principle, they may contain all the usual polymers. Examples of thermoplastically softenable adhesives are hotmelt adhesives based on ethylene/vinyl acetate copolymers, polybutenes, styrene/isoprene/styrene and styrene/butadiene/styrene copolymers, thermoplastic elastomers, amorphous polyolefins, linear thermoplastic polyurethanes, copolyesters, polyamide resins, polyamide/EVA copolymers, polyaminoamides based on dimer fatty acids, polyester amides or polyether amides. Other suitable adhesives are, in principle, the known two-pack adhesives based on one- or two-component polyurethanes, one- or two-component polyepoxides, silicone polymers (one or two components), the silane-modified polymers described, for example, in G. Habenicht, “Kleben: Grundlagen, Technologie, Anwendungen”, 3rd Edition, 1997, Chapter 2.3.4.4. The (meth)acrylate-functional two-pack adhesives based on peroxidic hardeners, anaerobic curing mechanisms, aerobic curing mechanisms or UV curing mechanisms are also suitable as the adhesive matrix.

The adhesives are preferably low-solvent types, i.e. they contain less than 1% by weight of organic materials boiling at temperatures below 200° C.

Suitable frequencies for the selective heating of the primer layer are any electromagnetic fields from 1 Hz to 100 GHz. Magnetic alternating fields with frequencies from 10 KHz to 10 GHz are particularly suitable.

The process according to the invention counters the known difficulties involved in the use of thermoplastic and/or reactive hotmelt adhesives by the use of a modified adhesive system—applied to one side—of a primer and a hotmelt adhesive with optimized spotting tack, optionally with the additional aid of conventional activation processes, to facilitate exact positioning, for example of the sole on the shoe base or an inner sole. The composite structure thus produced is then pressed in a device suitable for the process according to the invention and is activated by electromagnetic energy in that state, as described above. In this way, the adhesive layer adjacent the primer layer is crosslinked in a state for optimal penetration/wetting through the selective heating of the primer layer and hence the adjacent adhesive layer. In this way, the standards laid down in EN 522 and EN 1392 are achieved or surpassed.

In another embodiment of the process according to the invention, the bonded structure is cooled in the pressed state after activation. The advantage of this is that it eliminates the risk of unwanted opening of the bonded structure—still warm after activation—through recovery forces at work in the shoe material.

The present invention also relates to a process for establishing adhesive bonds by means of electrical, magnetic or electromagnetic alternating fields, the adhesive layer containing nanoscale particles which directly heat the adhesive layer under the influence of these alternating fields. The object of heating the adhesive layer in this way is to increase the strength of the bonds through better wetting or penetration by the heated adhesive, more particularly the hotmelt adhesive. The nanoscale particles act as fillers with “signal receiver” properties so that energy in the form of electromagnetic alternating fields is purposefully introduced into the adhesive bond. The introduction of energy into the adhesive results in a considerable local increase in temperature so that the viscosity is reduced.

The process according to the invention is distinguished from the conventional methods of heating by the fact that the heat is generated in the adhesive joint itself and is locally confined thereto and by the fact that the substrate materials to be bonded are subjected to little or no heat stress. The process is very quick and effective because the heat does not have to be introduced into the adhesive joint by diffusion through the substrates. The process according to the invention also considerably reduces heat losses through dissipation or radiation through the substrate so that it is particularly economical. Above all, however, the nanoscale particles at best merely impede but do not prevent spraying of the adhesive melt.

Electrical alternating fields or magnetic alternating fields are suitable for the introduction of energy. Where electrical alternating fields are applied, suitable filler materials are any piezoelectric compounds, for example quartz, tourmaline, barium titanate, lithium sulfate, potassium (sodium) tartrate, ethylenediamine tartrate, ferroelectric materials of perovskite structure and, above all, lead zirconium titanate. Where magnetic alternating fields are used, any ferrimagnetic, ferromagnetic or superparamagnetic materials are basically suitable, more particularly the metals aluminium, cobalt, iron, nickel or alloys thereof and metal oxides of the n-maghemite type (γ-Fe₂O₃) and the n-magnetite type (Fe₃O₄), ferrites with the general formula MeFe₂O₄, where Me stands for divalent metals from the group consisting of copper, zinc, cobalt, nickel, magnesium, calcium or cadmium.

Where magnetic alternating fields are used, nanoscale superparamagnetic particles, so-called single domain particles, are particularly suitable. Compared with the paramagnetic particles known from the prior art, the nanoscale fillers are distinguished by the fact that they have no hysteresis. The result of this is that the dissipation of energy is not produced by magnetic hysteresis losses, instead the generation of heat is attributable to an oscillation or rotation of the particles in the surrounding matrix induced during the action of an electromagnetic alternating field and, hence, ultimately to mechanical friction losses. This leads to a particularly effective heating rate of the particles and the matrix surrounding them.

Nanoscale particles in the context of the present invention are particles with a mean particle size (or a mean particle diameter) of no more than 500 nm and preferably no more than 300 nm. The nanoscale particles to be used in accordance with the invention preferably have a mean particle size of 1 to 40 nm and more preferably 3 to 30 nm. In order to utilize the effects through superparamagnetism, the particle sizes should be no more than 30 nm. The particle size is preferably determined by the UPA (ultrafine particle analyzer) method, for example by laser light back scattering. In order to prevent or avoid agglomeration or coalescence of the nanoscale particles, the particles are normally surface-modified or surface-coated. A corresponding process for the production of agglomerate-free nanoscale particles, for example iron oxide particles, is described in columns 8 to 10 of DE-A-196 14 136. Methods for the surface coating of such nanoscale particles for avoiding agglomeration thereof are disclosed in DE-A-197 26 282.

The nanoscale materials are added to the adhesive in a quantity of 1 to 30% by weight and preferably 3 to 10% by weight, based on the composition as a whole.

In principle, any relatively high-frequency electromagnetic alternating field may be used as the energy source for heating the nanoscale particles. For example, electromagnetic radiation of the so-called ISM (industrial, scientific and medical applications) ranges, i.e. frequencies between 100 MHz and about 200 GHz, may be used, cf. inter alia Kirk-Othmer, “Encyclopedia of Chemical Technology”, 3rd Edition, Vol. 15, chapter entitled “Microwave technology”, for further particulars.

It was pointed out in the foregoing that, where nanoscale particles according to the invention are used, electromagnetic radiation may be used to particular effect. This is clearly reflected in the fact that, even in the low-frequency range of about 50 kHz or 100 kHz up to 100 MHz, virtually any frequency can be used to produce the amount of heat needed to split the adhesive bond matrix in the adhesive matrix. A frequency range of 500 kHz to 50 MHz may advantageously be used. The choice of the frequency may be determined by the equipment available, care naturally having to be taken to ensure that interference fields are not radiated.

The adhesives containing the nanoscale particles may be used with or without primers for bonding porous and/or nonporous substrates because they may readily be applied by spraying.

1. A process for bonding substrates with hotmelt adhesive comprising:
(a) providing at least two substrates for bonding together;
(b) optionally, applying at least one primer to at least one of the substrates;
(c) spraying at least one hotmelt adhesive in liquid form containing nanoscale particles having ferromagnetic, ferromagnetic, superparamagnetic or piezoelectric properties onto at least one of the substrates;
(d) pressing the at least two substrates together so that the optional primer and the hotmelt adhesive are between the substrates and exposing at least the hotmelt adhesive to at least one alternating field selected from the group consisting of electrical, magnetic and electromagnetic alternating fields to heat the hotmelt adhesive; and
(e) cooling the hotmelt adhesive.

2. The process of claim 1 wherein one of the substrates is porous and the other substrate is porous or nonporous.

3. The process of claim 2 wherein at least one of the substrates is a porous woven or nonwoven fibrous substrate selected from leather or a textile.

4. The process of claim 1, wherein the hotmelt adhesive is thermoplastic.

5. The process of claim 1 wherein the substrates having the hotmelt adhesive in between are pressed together under a pressure ranging from 0.5 bar to 6 bar for a time period ranging from 5 seconds to 20 minutes.

6. The process of claim 5 wherein the substrates are pressed together under a pressure ranging from 2 bar to 5 bar for a time period ranging from 10 seconds to 30 seconds.

7. The process of claim 1 wherein after exposing the hotmelt adhesive to the alternating field, the substrates remain pressed together at least until after the hotmelt adhesive begins to solidify.

8. The process of claim 7 wherein the substrates remain pressed together at least until the hotmelt adhesive has cooled to a temperature of about 30° C.

9. The process of claim 1 wherein the substrates are components of a shoe and the process is part of an in-line process for making shoes.

10. The process of claim 1 wherein the nanoscale particles have a particle size of not more than 500 nm.

11. The process of claim 1 wherein the hotmelt adhesive contains from 1 to 30 weight percent of the nanoscale particles.

12. The process of claim 1 wherein the hotmelt adhesive is reactive.

13. The process of claim 1 wherein the hotmelt adhesive contains less than 1% by weight of organic materials boiling at temperatures below 200° C.

14. The process of claim 1 wherein the nanoscale particles have a particle size of not more than 300 nm.

15. The process of claim 1 wherein the nanoscale particles have a mean particle size of from 1 to 40 nm.

16. The process of claim 1 wherein the nanoscale particles have a mean particle size of from 3 to 30 nm.

17. The process of claim 1 wherein the hotmelt adhesive contains from 3 to 10 weight percent of the nanoscale particles.

18. The process of claim 1 wherein the alternating field is an electrical alternating field and said nanoscale particles comprise one or more materials selected from the group consisting of quartz, tourmaline, barium titanate, lithium sulfate, potassium (sodium) tartrate, ethylenediamine tartrate, ferroelectric materials of perovskite structure, and lead zirconium titanate.

19. The process of claim 1 wherein the alternating field is a magnetic alternating field and said nanoscale particles comprise one or more materials selected from the group consisting of aluminum metal, cobalt metal, iron metal, nickel metal, aluminum alloys, cobalt alloys, iron alloys, nickel alloys, metal oxides of the n-maghemite type, metal oxides of the n-magnetite type, and ferrites of general formula MeFe₂O₄, wherein Me is a divalent metal selected from the group consisting of copper, zinc, cobalt, nickel, magnesium, calcium and cadmium.

20. The process of claim 1 wherein the alternating field is a magnetic alternating field and said nanoscale particles are nanoscale superparamagnetic particles.
